(19) United States
(12) Patent Application Publication
(10) Pub. No.: US 2022/0041471 A1
(43) Pub. Date: Feb. 10, 2022

(54) BALLAST WATER TREATMENT APPARATUS

(71) Applicant: MIURA CO., LTD., Matsuyama-shi (JP)

(72) Inventor: Atsuyuki MANABE, Matsuyama-shi (JP)

(73) Assignee: MIURA CO., LTD., Matsuyama-shi (JP)

(21) Appl. No.: 17/338,687

(22) Filed: Jun. 4, 2021

(30) Foreign Application Priority Data
Aug. 5, 2020 (JP) 2020-133222

(51) Int. Cl. C02F 1/32; C02F 1/00; B63J 4/00

(52) U.S. Cl. CPC C02F 1/325; C02F 1/008; B63J 4/002; C02F 2103/008; C02F 2201/326; C02F 2303/04; C02F 2209/40

(57) ABSTRACT

To provide a ballast water treatment apparatus capable of determining a proper operation mode.

According to the present invention, a ballast water treatment apparatus includes a flow rate adjustment section configured to adjust the treatment flow rate of the flowing ballast water, an ultraviolet reactor capable of adjusting an ultraviolet irradiation amount, a transmittance acquisition section configured to acquire the ultraviolet transmittance of the flowing ballast water, and a control section configured to control the flow rate adjustment section and the ultraviolet reactor in one operation mode selected from multiple operation modes. In each of the multiple operation modes, the treatment flow rate and the ultraviolet irradiation amount are defined for each ultraviolet transmittance. The control section acquires the ultraviolet transmittance from the transmittance acquisition section before the purification treatment, and determines a proper operation mode based on the ultraviolet transmittance as a determination reference.

### BACKGROUND

### 1. TECHNICAL FIELD

The present invention relates to a ballast water treatment apparatus including an ultraviolet reactor. This application claims priority from Japanese Patent Application No. 2020-133222 filed in Japan on Aug. 5, 2020, the entire contents of which are hereby incorporated by reference.

### 2. Description of the Related Art

When a ship such as a tanker sails again to a destination after a load such as crude oil has been unloaded, water called ballast water is normally stored in a ballast tank to keep balance of the ship during sailing. For preventing damage of an ecosystem due to injection/discharge of the ballast water, a ballast water treatment apparatus configured to perform purification treatment for the ballast water is provided at such a ship.

As one type of ballast water treatment apparatus, one including an ultraviolet reactor to irradiate microorganisms in ballast water with ultraviolet light to kill the microorganisms has been known (see, e.g., JP-A-2014-227063).

### SUMMARY

In a case where the ballast water treatment apparatus as described above is used to perform the purification treatment for the ballast water to store the ballast water and subsequently discharge the ballast water, such treatment needs to comply with discharge regulations set by an agency such as the International Maritime Organization (IMO) or the United States Coast Guard (USCG). For enforcing these discharge regulations, the ballast water treatment apparatus needs, by specifications compliant with the discharge regulations, to have type approval by a predetermined agency. Note that there are multiple approval agencies providing type approval for the same discharge regulations (e.g., the USCG discharge regulations), and the type approval for the same discharge regulations can be obtained by multiple specifications (operation modes).

However, even in a case where the ballast water treatment apparatus can be operated in the multiple type-approved operation modes, it is difficult to select a proper operation mode according to a situation.

The present invention has been made in view of the above-described situation, and is intended to provide a ballast water treatment apparatus capable of determining a proper operation mode in a case where multiple operation modes are provided.

According to the present invention, a ballast water treatment apparatus for performing purification treatment for flowing ballast water is provided. The ballast water treatment apparatus includes a flow rate adjustment section configured to adjust the treatment flow rate of the flowing ballast water, an ultraviolet reactor capable of adjusting an ultraviolet irradiation amount, a transmittance acquisition section configured to acquire the ultraviolet transmittance of the flowing ballast water, and a control section configured to control the flow rate adjustment section and the ultraviolet reactor in one operation mode selected from multiple operation modes. In each of the multiple operation modes, the treatment flow rate and the ultraviolet irradiation amount are defined for each ultraviolet transmittance. The control section acquires the ultraviolet transmittance from the transmittance acquisition section before the purification treatment, and determines a proper operation mode based on the ultraviolet transmittance as a determination reference.

According to the present invention, in a case where the ballast water treatment apparatus includes the multiple operation modes, the transmittance acquisition section acquires the ultraviolet transmittance, and the control section acquires the ultraviolet transmittance and uses the ultraviolet transmittance as the determination reference. Thus, the proper operation mode can be determined. Moreover, the determined proper operation mode is provided to a user, or automatic switching to such an operation mode is made by the control section. In this manner, the ballast water treatment apparatus can be operated in the proper operation mode according to a situation.

Hereinafter, various embodiments of the present invention will be described as examples. The embodiments described below can be combined with each other.

Preferably, the transmittance acquisition section is a transmittance measurement sensor configured to measure the ultraviolet transmittance, and the control section acquires the ultraviolet transmittance from the transmittance measurement sensor.

Preferably, the transmittance acquisition section holds previous operation data and predicts a current ultraviolet transmittance from the previous operation data in advance, and the control section acquires the predicated ultraviolet transmittance.

Preferably, the transmittance acquisition section acquires the ultraviolet transmittance in the preliminary operation of discharging the ballast water without the ballast water being stored in a ballast tank, and the control section acquires the ultraviolet transmittance from the transmittance acquisition section.

Preferably, the control section acquires an acceptable treatment time for ballast operation and compares the acceptable treatment time and necessary treatment time for each operation mode, the necessary treatment time being calculated from the treatment flow rate corresponding to the ultraviolet transmittance acquired from the transmittance acquisition section.

Preferably, for each of the multiple operation modes, a tank holding time for which treated ballast water needs to be held in the ballast tank is set. The control section acquires an acceptable discharge time until the ballast water treated by the ultraviolet reactor is discharged after having been stored in the ballast tank, and compares the acceptable discharge time and the tank holding time.

Preferably, the multiple operation modes include a first mode and a second mode. The treatment flow rate in a case where the ultraviolet transmittance is equal to or higher than a predetermined value is set higher in the first mode than in the second mode, and the treatment flow rate in a case where the ultraviolet transmittance is lower than the predetermined value is set higher in the second mode than the first mode.

Preferably, in a case where control can be performed in any of the multiple operation modes, the operation mode with a smaller power consumption is determined as the proper operation mode.

### BRIEF DESCRIPTION OF THE DRAWINGS

FIG. 1 is a conceptual diagram showing a ballast water treatment apparatus 10 according to one embodiment of the present invention and a state in which the ballast water treatment apparatus 10 is installed into a ballast apparatus 1 of a ship;

FIG. 2 is a block diagram showing a main configuration of the ballast water treatment apparatus 10 of FIG. 1;

FIG. 3 is a flowchart showing an algorithm for determining a proper operation mode by the ballast water treatment apparatus 10 of FIG. 1;

FIG. 4 is a graph showing a relationship between an ultraviolet transmittance and a treatment flow rate defined for each of a first mode M1 and a second mode M2;

FIG. 5 is a diagram showing a flow path in ballast operation of the ballast apparatus 1 of FIG. 1;

FIG. 6 is a diagram showing a flow path in deballast operation of the ballast apparatus 1 of FIG. 1; and

FIG. 7 is a diagram showing a flow path in preliminary operation of the ballast apparatus 1 of FIG. 1.

### DESCRIPTION OF THE EMBODIMENTS

Hereinafter, an embodiment of the present invention will be described. Various features described in the embodiment below can be combined with each other. Moreover, the invention is established independently for each feature.

### 1. Configuration of Ballast Apparatus 1

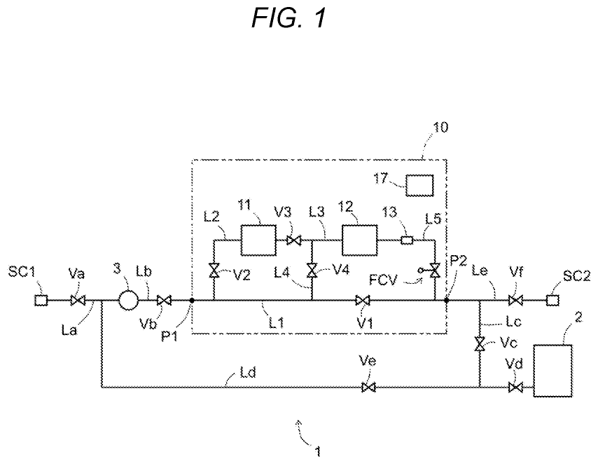

FIG. 1 is a conceptual diagram showing a state in which a ballast water treatment apparatus 10 as a liquid treatment apparatus according to the embodiment of the present invention is installed into a ballast apparatus 1 of a ship. The ballast apparatus 1 of the present application includes a ballast tank 2 and a ballast pump 3, and injects ballast water into the ballast tank 2 by the ballast pump 3 or discharges ballast water from the ballast tank 2 by the ballast pump 3. Note that the operation of taking water outside the ship, such as seawater, into the ship through a sea chest SC1 to inject the water into multiple ballast tanks 2 will be referred to as ballast operation, and the operation of discharging the ballast water stored in the ballast tank 2 through an ship external discharge port SC2 will be referred to as deballast operation. Moreover, regarding the “ballast water” in the present specification, all of water taken into the ship is expressed as the “ballast water” regardless of whether it is before introduction (inflow) into the ballast tank 2 or after discharge (outflow) from the ballast tank 2. Further, the ballast water taken into the ship includes, for example, seawater, freshwater, and brackish water.

As shown in FIG. 1, the ballast apparatus 1 includes lines La to Le connecting each component such that the ballast water flows in the lines La to Le and on-off valves Va to Vf provided on these lines. The “line” described herein is a collective term of lines in which fluid can flow, such as a flow path, a channel, and a pipe line.

The relationship of connection among the lines will be specifically described. The line La is a line connecting the sea chest SC1 and the ballast pump 3 to each other, and has the on-off valve Va. The line Lb and the line Lc are lines connecting the ballast pump 3 and the ballast tank 2. The ballast water treatment apparatus 10 is arranged between the ballast pump 3 and the ballast tank 2, and therefore, an upstream side with respect to the ballast water treatment apparatus 10 is the line Lb, and a downstream side with respect to the ballast water treatment apparatus 10 is the line Lc. The line Lb has the on-off valve Vb, and the line Lc has the on-off valve Vc and the on-off valve Vd. The lines La to Lc will be also collectively referred to as a ballast line.

The line Ld is, at one end thereof, connected to the line La at a location between the on-off valve Va and the ballast pump 3, and at the other end thereof, is connected to the line Lc on a ballast tank 2 side with respect to the on-off valve Vc. The on-off valve Ve is placed on the line Ld. The line Ld is a line used in the deballast operation, and will be also referred to as a deballast line. The line Le is, at one end thereof, connected to the line Lc at a location between the ballast water treatment apparatus 10 and the on-off valve Vc, and at the other end thereof, is connected to the ship external discharge port SC2. The on-off valve Vf is placed on the line Le.

Note that the above-described configuration of the ballast apparatus 1 has been described merely as one example of a ballast apparatus targeted for installation of the ballast water treatment apparatus 10 according to the present invention, and the ballast water treatment apparatus 10 described below is applicable to a ballast apparatus with an optional configuration.

### 2. Configuration of Ballast Water Treatment Apparatus 10

Next, the configuration of the ballast water treatment apparatus 10 will be described. The ballast water treatment apparatus 10 is installed to treat the ballast water taken into the ship and the ballast water discharged from the ship to reduce the content of microorganisms/extraneous substances in the ballast water. As shown in FIG. 1, the ballast water treatment apparatus 10 of the present embodiment is provided between the ballast pump 3 and the ballast tank 2 (or the ship external discharge port SC2). It is assumed herein that on a flow path of the ballast water treatment apparatus 10, a ballast-pump-3-side connection portion connected to the line Lb is an upstream connection portion P1 and a ballast-tank-2-side connection portion connected to the line Lc is a downstream connection portion P2.

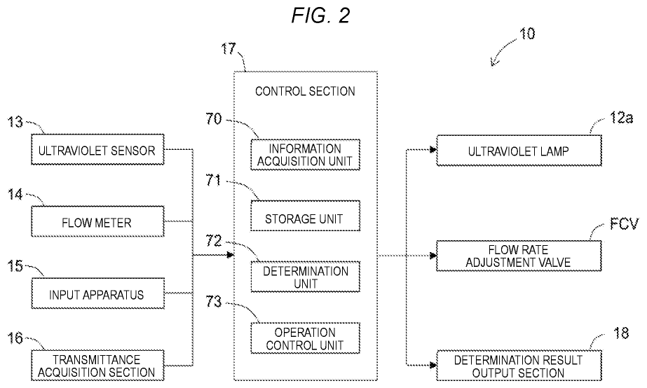

The ballast water treatment apparatus 10 of the present embodiment includes, a purification section, a filtration apparatus 11 configured to filtrate the ballast water by a filter and an ultraviolet reactor 12 configured to irradiate the ballast water with ultraviolet light to sterilize microorganisms. Moreover, as shown in FIG. 2, the ballast water treatment apparatus 10 includes a flowmeter 13, an ultraviolet sensor 14, an input apparatus 15, a transmittance acquisition section 16, a control section 17, and a determination result output section 18. Note that a known optional configuration can be applied to the filtration apparatus 11, or the filtration apparatus 11 can be omitted.

In addition, the ballast water treatment apparatus 10 includes, as shown in FIG. 1, first to fifth lines L1 to L5 connecting each component such that the ballast water flows in the first to fifth lines L1 to L5, on-off valves V1 to V4 placed on these lines, and a flow rate adjustment valve FCV as a flow rate adjustment section.

The first line L1 is a line (a bypass line) bypassing the purification section (the filtration apparatus 11 and the ultraviolet reactor 12) to connect the upstream connection portion P1 and the downstream connection portion P2 to each other, and has the on-off valve V1. The second line L2 is a line connecting the first line L1 and the filtration apparatus 11, and has the on-off valve V2. The third line L3 is a line connecting the filtration apparatus 11 and the ultraviolet reactor 12, and has the on-off valve V3. The fourth line L4 is, at one end thereof, connected to a location which is on the downstream side with respect to the location of connection between the first line L1 and the second line L2 and on the upstream side with respect to the on-off valve V1, and at the other end thereof, is connected to a location on the downstream side with respect to the on-off valve V3 of the third line L3. The fourth line L4 has the on-off valve V4. The fifth line L5 is, at one end thereof, connected to the ultraviolet reactor 12, and at the other end thereof, is connected to a location on the downstream side with respect to the on-off valve V1 of the first line L1. The flowmeter 13 and the flow rate adjustment valve FCV of which degree of opening is adjustable are provided on the fifth line L5 (also see FIG. 2).

The ultraviolet reactor 12 is configured such that multiple ultraviolet lamps 12a (see FIG. 2) are arranged inside a not-shown treatment tank. The ultraviolet reactor 12 irradiates, by the ultraviolet lamps 12a, the ballast water flowing in the treatment tank with the ultraviolet light, thereby sterilizing the microorganisms. The ultraviolet reactor 12 of the present embodiment controls ON/OFF of each ultraviolet lamp 12a and/or power to be supplied to each ultraviolet lamp 12a, thereby adjusting the intensity of the ultraviolet light with which the ballast water is irradiated.

The flowmeter 13 measures the flow rate of the ballast water flowing in the ultraviolet reactor 12. In the present embodiment, the flowmeter 13 is provided on the fifth line L5, but may be provided at other locations as long as the flowmeter 13 is on the ballast water flow path when sterilization treatment is performed by the ultraviolet reactor 12. By the flowmeter 13 and adjustment of the degree of opening of the flow rate adjustment valve FCV as described above, the flow rate (hereinafter referred to as a treatment flow rate) of the ballast water flowing in the ballast water treatment apparatus 10 can be adjusted.

The ultraviolet sensor 14 is placed at the ultraviolet reactor 12 to measure the illumination intensity of the ultraviolet light from the ultraviolet lamp 12a through the ballast water. An ultraviolet irradiation amount as the amount of irradiation with the ultraviolet light per unit flow rate is calculated from the flow rate of the ballast water measured by the flowmeter 13 and the ultraviolet light illumination intensity measured by the ultraviolet sensor 14.

The input apparatus 15 is an apparatus configured to receive various types of input from a user such as a crew. Examples of the input apparatus 15 include a mouse and a keyboard connected to an information processing apparatus such as a personal computer, a display to which input can be made via a touch panel, and a sound input apparatus. Note that an optional device can be used as long as various types of input can be received from the user. Various types of input received from the user as described herein include, for example, information on the current location of the ship, information on the total amount of the ballast water which needs to be stored, information on the navigation destination (the destination) of the ship, information on time taken until the ship leaves a port after having arrived in the port, and information on time taken until the ship in harbor arrives in a port as the navigation destination after having left a port.

Note that an acceptable treatment time for the ballast operation is calculated from the information on the time taken until the ship leaves the port after having arrived in the port. Moreover, an acceptable discharge time until the treated ballast water is discharged after having been stored in the ballast tank is calculated from the time taken until the ship in harbor arrives in the port as the navigation destination after having left the port. Preferably, the input apparatus 15 is placed at a ballast controller configured to control operation of the ballast apparatus 1.

The transmittance acquisition section 16 acquires the ultraviolet transmittance of the ballast water flowing in the ultraviolet reactor 12. In the present embodiment, the transmittance acquisition section 16 is a transmittance measurement sensor capable of measuring the ultraviolet transmittance of the ballast water. The transmittance measurement sensor is not necessarily provided on the ballast water flow path in the ballast water treatment apparatus 10, and is placed at such an optional location of the ship that seawater is easily taken into the ship.

The control section 17 controls opening/closing of the on-off valves Va to Vf, the on-off valves V1 to V4, and the flow rate adjustment valve FCV as described above, thereby adjusting the flow rate of the ballast water flowing in the ballast water treatment apparatus 10. Moreover, the control section 17 controls the output of the ultraviolet lamp 12a of the ultraviolet reactor 12, thereby adjusting the amount of irradiation of the ballast water with the ultraviolet light. Adjustment of the flow rate of the ballast water by the control of opening/closing of the flow rate adjustment valve FCV and adjustment of the amount of irradiation of the ballast water with the ultraviolet light by the control of the output of the ultraviolet reactor 12 are performed in one operation mode selected from first to third modes M1 to M3 described later. Specifically, the control section 17 includes, as shown in FIG. 2, an information acquisition unit 70, a storage unit 71, a determination unit 72, and an operation control unit 73.

The information acquisition unit 70 acquires the flow rate of the flowing ballast water from the flowmeter 13, acquires various types of input made to the input apparatus 15 by the crew, and acquires the ultraviolet transmittance of the ballast water from the transmittance acquisition section 16.

The storage unit 71 has the function of storing various types of data. The storage unit 71 stores, for each of the first to third modes M1 to M3, the treatment flow rate and the ultraviolet irradiation amount defined for each ultraviolet transmittance. Moreover, the storage unit 71 stores a tank holding time T1 in the first mode M1 and a tank holding time T2 in the second mode M2 as described later.

The determination unit 72 determines a proper operation mode from the information acquired by the information acquisition unit 70 and the information stored in the storage unit 71.

The operation control unit 73 controls the degree of opening of the flow rate adjustment valve FCV and the intensity of the ultraviolet lamp 12a of the ultraviolet reactor 12 by any operation mode of the first to third modes M1 to M3. In this manner, the treatment flow rate of the ballast water and the amount of irradiation of the ballast water with the ultraviolet light are adjusted.

Note that the control section 17 with the above-described configuration may specifically include an information processing apparatus having a CPU, a memory (e.g., a flash memory), an input unit, and an output unit. The processing by each of the above-described components of the control section 17 including the information processing apparatus is performed in such a manner that the CPU reads and executes a program stored in the memory. For example, as the information processing apparatus, a personal computer, a programmable logic controller (PLC), or a microcomputer is used. Note that it may be configured such that some of the functions of the control section 17 are executed on a cloud connected via an optional communication section.

The determination result output section 18 is for providing, to the user, the proper operation mode determined by the determination unit 72 of the control section 17. For example, as the determination result output section 18, a display apparatus such as a display is used. In a case where the input apparatus 15 includes the display, such a display is preferably shared.

### 3. Operation of Ballast Water Treatment Apparatus 10

The ballast water treatment apparatus 10 of the present embodiment includes the three operation modes of the first to third modes M1 to M3. Upon ballast water purification treatment executed in the ballast operation, the ballast water treatment apparatus 10 first executes, after the proper operation mode has been determined by a mode determination step, a purification step in the determined operation mode.

In each operation mode, the treatment flow rate and the ultraviolet irradiation amount are defined for each ultraviolet transmittance, and the treatment flow rate and the ultraviolet irradiation amount for each ultraviolet transmittance are stored in the storage unit 71. The control section 17 controls the degree of opening of the flow rate adjustment valve FCV and the intensity of the ultraviolet lamp 12a of the ultraviolet reactor 12 such that the purification treatment is performed with the treatment flow rate and the ultraviolet irradiation amount defined for each operation mode. Note that in any operation mode, the treatment flow rate is set higher as the ultraviolet transmittance increases. This is because the ultraviolet irradiation amount increases as the ultraviolet transmittance increases even in the case of the same output of the ultraviolet lamp 12a.

### Each Operation Mode

In the present embodiment, the first mode M1 and the second mode M2 are operation modes compliant with discharge regulations set by the United States Coast Guard (USCG). That is, any of the first mode M1 and the second mode M2 is an operation mode having type approval by an agency set by the United States Coast Guard (USCG). On the other hand, the third mode M3 is an operation mode compliant with discharge regulations set by the International Maritime Organization (IMO), and is an operation mode having type approval by an agency set by the International Maritime Organization (IMO). Thus, in a case where the navigation destination of the ship is the United States of America or a sea therearound (hereinafter referred to as a sea area A), operation is performed in the first mode M1 or the second mode M2. In a case where the navigation destination of the ship is not the sea area A, operation is performed in the third mode M3. Thus, such operation complies with each discharge regulation.

According to the discharge regulations set by the United States Coast Guard (USCG), it is set such that the ballast water stored once is not discharged until a predetermined time elapses, and the time for which no ballast water is discharged is called a “tank holding time” or a “holding time.” Thus, in the first mode M1 and the second mode M2, the time (hereinafter referred to as the acceptable discharge time) until the treated ballast water is discharged after having been stored in the ballast tank 2 needs to be longer than a predetermined tank holding time. In a case where the acceptable discharge time is shorter than the tank holding time, the ballast water cannot be discharged until the tank holding time elapses even though the ship arrives in the port as the destination. The tank holding time T1 in the first mode M1 and the tank holding time T2 in the second mode M2 are stored in the storage unit 71. In the present embodiment, the tank holding time T1 in the first mode M1 is longer than the tank holding time T2 in the second mode M2 (T1>T2).

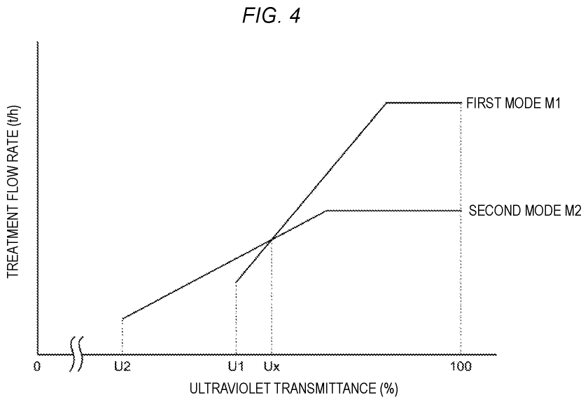

In addition, when the first mode M1 and the second mode M2 are compared with each other, the treatment flow rate in a case where the ultraviolet transmittance is equal to or higher than a predetermined value Ux is set higher in the first mode M1 than in the second mode M2, and the treatment flow rate in a case where the ultraviolet transmittance is lower than the predetermined value Ux is set higher in the second mode M2 than in the first mode M1, as shown in FIG. 4. That is, the predetermined value Ux for the ultraviolet transmittance is a value at which a magnitude relationship between the treatment flow rate in the first mode M1 and the treatment flow rate in the second mode M2 is switched. Further, the lower transmittance limit U2 of the ultraviolet transmittance treatable in the second mode M2 is lower than the lower transmittance limit U1 of the ultraviolet transmittance treatable in the first mode M1. Thus, in a case where the ultraviolet transmittance is equal to or lower than the lower transmittance limit U1 in the first mode M1, the ballast water purification treatment can be performed only in the second mode M2.

Note that a power consumption in the first mode M1 is smaller than a power consumption in the second mode M2.

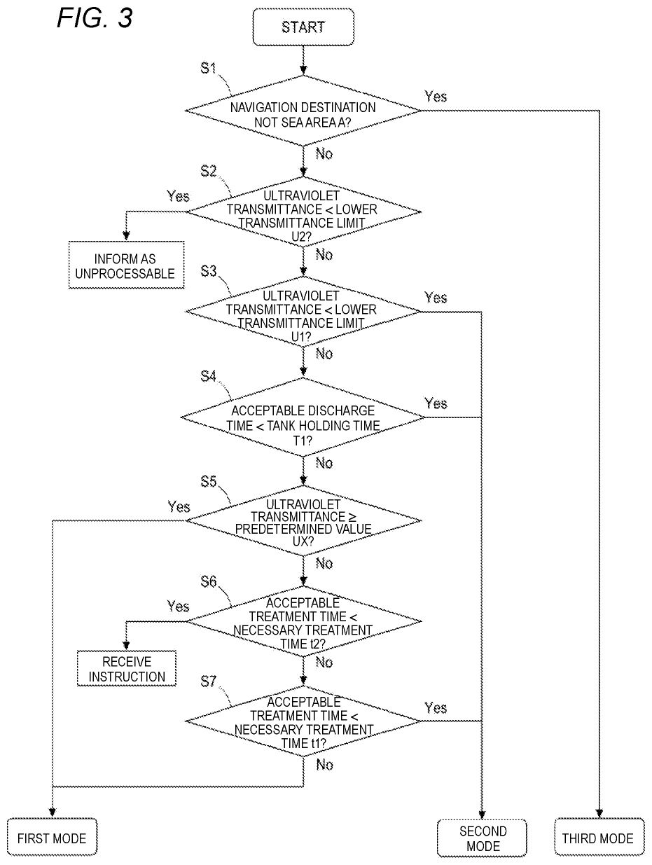

Hereinafter, one example of an algorithm for determining the proper operation mode will be described with reference to FIG. 3. The mode determination step is started at such timing that, e.g., the crew requests mode determination or the ship arrives in the port.

### Mode Determination Step

At a step S1 of the mode determination step, the information acquisition unit 70 of the control section 17 first acquires information, which has been input to the input apparatus 15, on a next navigation destination of the ship. At this point, the storage unit 71 stores information on whether or not the port as the navigation destination belongs to the sea area A, and from the input information on the navigation destination of the ship and such stored information, the determination unit 72 determines whether or not the navigation destination belongs to the sea area A. In a case where the navigation destination is the sea area A, the determination unit 72 determines that the proper operation mode is the third mode M3, and the mode determination step ends. In a case where the navigation destination is not the sea area A, the processing proceeds to a next step. Note that it may be configured such that the information on whether or not the navigation destination belongs to the sea area A is directly input to the input apparatus 15.

Next, at a step S2, the information acquisition unit 70 acquires the ultraviolet transmittance of seawater at a current location from the transmittance acquisition section 16. The determination unit 72 determines whether or not the acquired ultraviolet transmittance is lower than the lower transmittance limit U2 (see FIG. 4) in the second mode M2. In a case where the ultraviolet transmittance is lower than the lower transmittance limit U2 in the second mode M2, the determination unit 72 determines that the treatment cannot be performed in any operation mode due to an extremely-low water quality. The determination result output section 18 informs the user of such determination. At a step S3, the determination unit 72 determines whether or not the acquired ultraviolet transmittance is lower than the lower transmittance limit U1 (see FIG. 4) of the ultraviolet transmittance treatable in the first mode M1. In a case where the ultraviolet transmittance is lower than the lower transmittance limit U1 in the first mode M1, operation cannot be performed in the first mode M1 (see FIG. 4), and for this reason, the determination unit 72 determines that the proper operation mode is the second mode M2 and the mode determination step ends. In a case where the ultraviolet transmittance is not lower than the lower transmittance limit U1 in the first mode M1, the processing proceeds to a next step.

Next, at a step S4, the information acquisition unit 70 acquires the acceptable discharge time input to the input apparatus 15. Moreover, the information acquisition unit 70 reads the tank holding time T1 (longer than the tank holding time T2 in the second mode M2) in the first mode M1 from the storage unit 71. In a case where the acceptable discharge time is shorter than the tank holding time T1 in the first mode M1, i.e., the ballast water needs to be held beyond the acceptable discharge time in the first mode M1, the determination unit 72 determines that the proper operation mode is the second mode M2 with a shorter tank holding time, and the mode determination step ends. In a case where the acceptable discharge time is longer than the tank holding time T1 in the first mode M1, the processing proceeds to a next step.

Next, at a step S5, the determination unit 72 compares the ultraviolet transmittance acquired from the transmittance acquisition section 16 and the predetermined value Ux at which the magnitude relationship between the treatment flow rate in the first mode M1 and the treatment flow rate in the second mode M2 is switched. In a case where the ultraviolet transmittance is equal to or higher than the predetermined value Ux, the determination unit 72 determines that the proper operation mode is the first mode M1 with a higher treatment flow rate in such a range (see FIG. 4), and the mode determination step ends. In a case where the ultraviolet transmittance is lower than the predetermined value Ux, the processing proceeds to a next step.

Next, at a step S6, the information acquisition unit 70 acquires the acceptable treatment time input to the input apparatus 15. The determination unit 72 reads, from the storage unit 71, the treatment flow rates in the first mode M1 and the second mode M2 for the ultraviolet transmittance acquired from the transmittance acquisition section 16. At this point, the ultraviolet transmittance in a case where the processing proceeds to the step S5 through the step S2 and the step S4 is equal to or higher than P1 and lower than Px. Moreover, the determination unit 72 calculates, from the acquired treatment flow rates per unit time and the total amount of the ballast water which needs to be stored, necessary treatment time t1 for the purification treatment in the first mode M1 and necessary treatment time t2 for the purification treatment in the second mode M2. At this point, as shown in FIG. 4, the treatment flow rate in a case where the ultraviolet transmittance is lower than the predetermined value Ux is higher in the second mode M2 than in the first mode Ml, and therefore, the necessary treatment time t2 in the second mode M2 is shorter than the necessary treatment time t1 in the first mode M1 (t1>t2). In a case where the acceptable treatment time is shorter than the necessary treatment time t2 in the second mode M2, the purification treatment cannot be completed within the acceptable treatment time in any operation mode. In this case, an instruction for determining whether the mode (the second mode M2) with a shorter treatment time or the mode (the first mode M1) with a smaller power consumption is to be selected is received from the user via the input apparatus 15, and the operation mode instructed by the user is determined as the proper operation mode.

At a next step S7, in a case where the acceptable treatment time is equal to or longer than the necessary treatment time t2 in the second mode M2 and shorter than the necessary treatment time t1 in the first mode M1, the purification treatment can be completed within the acceptable treatment time only in the second mode M2. Thus, it is determined that the optimal operation mode is the second mode M2, and the mode determination step ends. In a case where the acceptable treatment time is equal to or longer than the necessary treatment time t1 in the first mode M1, the purification treatment can be completed within the acceptable treatment time in any operation mode, and therefore, it is determined that the optimal operation mode is the first mode M1 with a smaller power consumption.

After it has been, by the steps S1 to S7 of the above-described mode determination step, determined that either one of the modes is the proper operation mode, the control section 17 provides, by the determination result output section 18, the determined proper operation mode to the user such as the crew. The user selects, with reference to the determination result provided by the determination result output section 18, the operation mode in which the ballast operation is to be actually performed, and via the input apparatus 15, inputs the operation mode to be executed. The operation control unit 73 of the control section 17 starts the following ballast operation in the input operation mode. Note that it may be configured such that the automatically-determined operation mode is selected without the determined proper operation mode being displayed on the display section and the ballast operation is started.

### Purification Step

Next, the purification step in the determined operation mode will be described. Note that each type of operation of the purification step is controlled by the control section 17, but part or the entirety of the operation may be manually performed by the crew.

FIG. 5 is a diagram showing the ballast water flow path in the ballast operation by the ballast apparatus 1. The lines La to Lc indicated by thick lines are the flow path in which the ballast water flows. In such operation, the on-off valves Va to Vd of the ballast apparatus 1 are opened, and the other on-off valves Ve, Vf are closed. At this point, in the ballast water treatment apparatus 10, the operation control unit 73 of the control section 17 performs the control of opening the on-off valves V2, V3 and the flow rate adjustment valve FCV and closing the on-off valves V1, V4. In this manner, the ballast water flows in part of the first line L1, the second line L2, the third line L3, and the fifth line L5, and flows in the filtration apparatus 11 and the ultraviolet reactor 12. At this point, the operation control unit 73 also outputs a start command for the filtration apparatus 11 and the ultraviolet reactor 12. The operation control unit 73 controls the degree of opening of the flow rate adjustment valve FCV and the intensity of the ultraviolet lamp 12a, thereby adjusting the treatment flow rate of the ballast water and the amount of irradiation of the ballast water with the ultraviolet light to numerical values defined for the operation mode selected by the mode determination step. By such control, the ballast water is purified by flowing in the filtration apparatus 11 and the ultraviolet reactor 12, and is stored in the ballast tank 2.

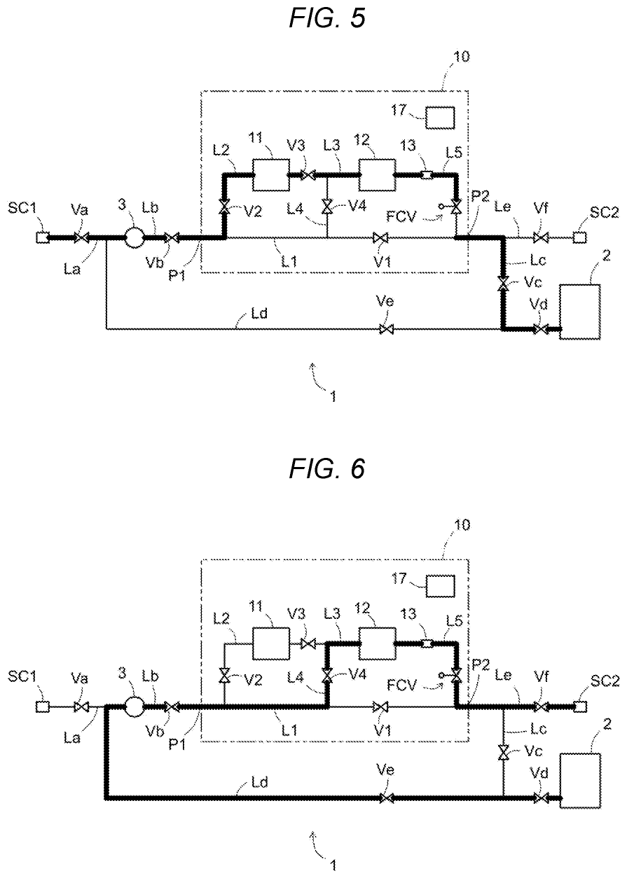

Note that FIG. 6 is a diagram showing the flow path in the deballast operation of the ballast apparatus 1. Part of the line La, the line Lb, part of the line Lc, the line Ld, and the line Le indicated by thick lines are the flow path in which the ballast water flows in the deballast operation. In such operation, the on-off valves Vb, Vd to Vf are opened, and the other on-off valves Va, Vc are closed. At this point, in the ballast water treatment apparatus 10, the operation control unit 73 of the control section 17 performs the control of opening the on-off valve V4 and the flow rate adjustment valve FCV and closing the on-off valves V1 to V3. In this manner, the ballast water flows in the part of the first line L1, the fourth line L4, part of the third line L3, and the fifth line L5, bypasses the filtration apparatus 11, and flows only in the ultraviolet reactor 12. Moreover, the operation control unit 73 also outputs the start commend for the ultraviolet reactor 12. The ballast water stored in the ballast tank 2 flows in the ultraviolet reactor 12 so that the microorganisms/extraneous substances having grown while the ballast water is stored can be purified. Note that filtration treatment by the filtration apparatus 11 is not performed for the ballast water to be discharged to the outside of the ship because the filtration treatment is performed once in the ballast operation for the ballast water in the ballast tank 2.

### 4.Features and Advantageous Effects

As described above, according to the ballast water treatment apparatus 10 of the present embodiment, the multiple operation modes are provided so that the purification treatment can be properly performed according a sea area or a situation. Specifically, the ballast water treatment apparatus 10 of the present embodiment includes the transmittance acquisition section 16, and the ultraviolet transmittance is acquired by the transmittance acquisition section 16 and is used as a reference for determination by the determination unit 72 of the control section 17. Thus, the proper operation mode can be determined in the ballast operation.

For example, the information acquisition unit 70 of the control section 17 acquires the ultraviolet transmittance of seawater at the current location from the transmittance acquisition section 16, and the determination unit 72 determines whether or not the acquired ultraviolet transmittance is lower than the lower transmittance limit U1 (see FIG. 4) of the ultraviolet transmittance treatable in the first mode M1. With this configuration, in the case of the ultraviolet transmittance which cannot be treated in the first mode M1, it can be determined that the proper operation mode is the second mode M2 (see the step S2 of the mode determination step). For example, the determination unit 72 compares the ultraviolet transmittance and the predetermined value Ux at which the magnitude relationship between the treatment flow rate in the first mode M1 and the treatment flow rate in the second mode M2 is switched. With this configuration, among the first mode M1 and the second mode M2, the operation mode with a higher treatment flow rate can be determined as the proper operation mode (see the step S4 of the mode determination step). Note that as long as the transmittance measurement sensor is provided as the transmittance acquisition section 16, the proper operation mode can be determined in advance before the start of operation of the ballast water treatment apparatus 10.

In addition, the information acquisition unit 70 of the control section 17 acquires the acceptable treatment time input by the user via the input apparatus 15, and the determination unit 72 compares the acceptable treatment time and the necessary treatment times t1, t2 in the first mode M1 and the second mode M2, the necessary treatment times t1, t2 being calculated from the treatment flow rates corresponding to the ultraviolet transmittance acquired from the transmittance acquisition section 16. In this manner, the operation mode in which the ballast operation can be completed within the acceptable treatment time can be determined (see the step S5 of the mode determination step). At this point, in a case where the ballast operation can be completed within the acceptable treatment time in any operation mode, if it is determined that the optimal operation mode is the first mode M1 with a smaller power consumption, the power consumption can be reduced according to a situation.

The information acquisition unit 70 of the control section 17 acquires the acceptable discharge time until the ballast water is discharged after having been stored in the ballast tank 2, and the determination unit 72 compares the acceptable discharge time and the tank holding time T1 in the first mode M1 and the tank holding time T2 in the second mode M2 (T1>T2). In this manner, the operation mode in which loading and unloading can be started after the ballast water has been discharged within the acceptable discharge time can be determined (see the step S3 of the mode determination step).

### 5. Variations

Note that the present invention can be also implemented in the following forms.

In the above-described embodiment, the transmittance measurement sensor arranged at a location different from that of the ultraviolet reactor 12 is used as the transmittance acquisition section 16 configured to acquire the transmittance of the ballast water. However, the transmittance acquisition section 16 may be implemented as the function of the control section 17 instead of placing the transmittance measurement sensor as the transmittance acquisition section 16. Specifically, the control section 17 can hold previous operation data in the storage unit 71, and can predict a current ultraviolet transmittance in advance from the previous operation data and the current location of the ship acquired by, e.g., a GPS apparatus. The operation data saved in the storage unit 71 as described herein indicates an association among information on the location of the ship in previous operation of the ballast water treatment apparatus 10, the intensity of the ultraviolet lamp 12a, and the illumination intensity of the ultraviolet light emitted from the ultraviolet lamp 12a and measured by the ultraviolet sensor 14. For each sea area (or each port) where the ship has previously sailed, the transmittance of the ballast water is calculated from the intensity of the ultraviolet lamp 12a and the illumination intensity of the ultraviolet lamp 12a through the ballast water. Based on such a transmittance, the ultraviolet transmittance can be predicated in advance from the current location of the ship. Note that as the operation data saved in the storage unit 71, ultraviolet transmittances and location information acquired by multiple ships managed by, e.g., a manufacturer of the ballast water treatment apparatus 10 or a ship owner can be also utilized.

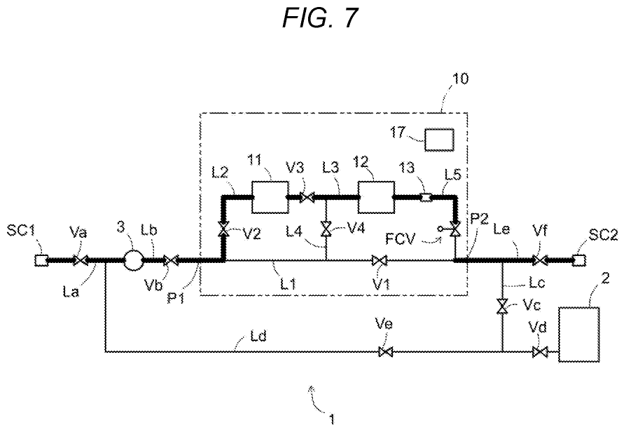

As an example where the transmittance acquisition section 16 is implemented as the function of the control section 17, the control section 17 can calculate the ultraviolet transmittance in the preliminary operation (see FIG. 7) of discharging the ballast water without storing the ballast water in the ballast tank 2. Specifically, in the preliminary operation, the ultraviolet lamps 12a are turned on, and the intensity of the ultraviolet lamp 12a is measured by the ultraviolet sensor 14. In this manner, the control section 17 can calculate the ultraviolet transmittance from the intensity of the ultraviolet lamp 12a and the illumination intensity of the ultraviolet light measured by the ultraviolet sensor 14.

In the above-described embodiment, the mode determination step includes the seven steps S1 to S7 as shown in FIG. 3. However, the mode determination step does not necessarily have one or more steps of these steps S1 to S7. For example, if the lower ultraviolet transmittance limits in the first mode M1 and the second mode M2 are the substantially same as each other, the step S5 is not necessarily provided. Alternatively, the mode determination step may have only one of the steps S1 to S7.

For example, in a case where the time until the ballast water is discharged after having been stored is constantly long, i.e., a case where the distance of a single sailing is constantly long, the tank holding time T1 in the first mode M1 and the tank holding time T2 in the second mode M2 are constantly shorter than the acceptable discharge time. Thus, the mode determination step does not necessarily have the step S3. In addition, the tank holding times T1, T2 are set for the first mode M1 and the second mode M2 of the above-described embodiment. However, in a case where no tank holding time is set for the first mode M1 and the second mode M2, the step S3 is not necessary, either. Further, in a case where the priority of the condition for the acceptable discharge time is low, determination of the acceptable treatment time at the steps S6, S7 can be first performed, and thereafter, determination of the acceptable discharge time at the step S4 can be performed.

In the above-described embodiment, the condition for the acceptable discharge time and the condition for the acceptable treatment time are satisfied in priority to the condition for the power consumption. However, in a case where the power consumption is reduced in priority to termination of operation within the acceptable treatment time and the acceptable discharge time, the output indicating that the operation mode with a smaller power consumption is the first mode M1 is, regardless of the steps S4, S6, S7, made to the determination result output section 18, and the determination result output section 18 may provide such information to the user.

In the above-described embodiment, the tank holding time T1 in the first mode M1 is longer than the tank holding time T2 in the second mode M2 (T1>T2), and may be shorter than the tank holding time T2 in the second mode M2 (T1<T2). In this case, at the above-described step S4, if the acceptable discharge time is shorter than T2, it is preferably determined that the first mode M1 is the proper operation mode. As a generalized concept, the control section 17 preferably compares, at the step S4, a longer one of the tank holding time T1 in the first mode M1 or the tank holding time T2 in the second mode M2 with the acceptable discharge time, and if the acceptable discharge time is shorter than the longer tank holding time, preferably determines the operation mode with a shorter tank holding time as the proper operation mode.

What is claimed is:

1. A ballast water treatment apparatus for performing purification treatment for flowing ballast water, comprising:
a flow rate adjustment section configured to adjust a treatment flow rate of the flowing ballast water;
an ultraviolet reactor capable of adjusting an ultraviolet irradiation amount;
a transmittance acquisition section configured to acquire an ultraviolet transmittance of the flowing ballast water; and
a control section configured to control the flow rate adjustment section and the ultraviolet reactor in one operation mode selected from multiple operation modes,
wherein in each of the multiple operation modes, the treatment flow rate and the ultraviolet irradiation amount are defined for each ultraviolet transmittance, and
the control section acquires the ultraviolet transmittance from the transmittance acquisition section before the purification treatment, and determines a proper operation mode based on the ultraviolet transmittance as a determination reference.

2. The ballast water treatment apparatus according to claim 1, wherein
the transmittance acquisition section is a transmittance measurement sensor configured to measure the ultraviolet transmittance, and
the control section acquires the ultraviolet transmittance from the transmittance measurement sensor.

3. The ballast water treatment apparatus according to claim 1, wherein
the transmittance acquisition section holds previous operation data, and predicts a current ultraviolet transmittance from the previous operation data in advance, and
the control section acquires the predicated ultraviolet transmittance.

4. The ballast water treatment apparatus according to claim 1, wherein
the transmittance acquisition section acquires the ultraviolet transmittance in a preliminary operation of discharging the ballast water without the ballast water being stored in a ballast tank, and
the control section acquires the ultraviolet transmittance from the transmittance acquisition section.

5. The ballast water treatment apparatus according to claim 1, wherein
the control section acquires an acceptable treatment time for ballast operation and compares the acceptable treatment time and necessary treatment time for each operation mode, the necessary treatment time being calculated from the treatment flow rate corresponding to the ultraviolet transmittance acquired from the transmittance acquisition section.

6. The ballast water treatment apparatus according to claim 1, wherein
for each of the multiple operation modes, a tank holding time for which treated ballast water needs to be held in the ballast tank is set, and
the control section acquires an acceptable discharge time until the ballast water treated by the ultraviolet reactor is discharged after having been stored in the ballast tank, and compares the acceptable discharge time and the tank holding time.

7. The ballast water treatment apparatus according to claim 6, wherein
the multiple operation modes include a first mode and a second mode,
the treatment flow rate in a case where the ultraviolet transmittance is equal to or higher than a predetermined value is set higher in the first mode than in the second mode, and
the treatment flow rate in a case where the ultraviolet transmittance is lower than the predetermined value is set higher in the second mode than the first mode.

8. The ballast water treatment apparatus according to claim 1, wherein
in a case where control is able to be performed in any of the multiple operation modes, an operation mode with a smaller power consumption is determined as the proper operation mode.
